(19) United States
(12) Patent Application Publication
(10) Pub. No.: US 2019/0358845 A1
(43) Pub. Date: Nov. 28, 2019

(54) METHOD FOR PRODUCTION OF A FRACTURE-SPLIT CONNECTING ROD

(71) Applicant: Miba Sinter Austria GmbH, Laakirchen (AT)

(72) Inventors: Jose Correa NETO, Campinas-SP (BR); Daniel Augusto PERUGINI, Salto (BR); Reginaldo INVERNIZZI, Intaiatuba-SP (BR)

(73) Assignee: Miba Sinter Austria GmbH, Laakirchen (AT)

(21) Appl. No.: 16/395,449

(22) Filed: Apr. 26, 2019

(30) Foreign Application Priority Data
May 24, 2018 (AT) A 50423/2018

(51) Int. Cl. B26F 3/00; F16C 7/00; F16C 9/04

(52) U.S. Cl. CPC B26F 3/002; F16C 7/00; F16C 2220/80; F16C 2220/20; F16C 9/045

(57) ABSTRACT

According to a method for production of a fracture-split connecting rod, a connecting rod having one large and one small connecting-rod eye is introduced into a holding jig and therein the connecting rod is fracture-split in the region of the large connecting-rod eye, so that the connecting rod is subdivided into a rod part and a cap part, and then the rod part and the cap part are removed from the holding jig once again, wherein the rod part and the cap part are clamped together with a clamping element, especially before they are removed as a whole from the holding jig.

### CROSS REFERENCE TO RELATED APPLICATIONS

Applicant claims priority under 35 U.S.C. § 119 of Austrian Application No. A 50423/2018 filed May 24, 2018, the disclosure of which is incorporated by reference.

### BACKGROUND OF THE INVENTION

### 1. Field of the Invention

The invention relates to a method for production of a fracture-split connecting rod, according to which a connecting rod having one large and one small connecting-rod eye is introduced into a holding jig and therein the connecting rod is fracture-split in the region of the large connecting-rod eye, so that the connecting rod is subdivided into a rod part and a cap part, and then the rod part and the cap part are removed from the holding jig once again.

### 2. Description of the Related Art

The fracture splitting of connecting rods in the region of the large connecting-rod eye is known in the prior art. The surface structure resulting at the fracture sites in this process permits the two parts produced during fracture splitting to fit together once again almost perfectly. This in turn favors the precision with which the connecting rod can be mounted.

### SUMMARY OF THE INVENTION

The task underlying the present invention is to create a possibility with which the precision of the assembly of the connecting rod is favored.

The task of the invention is accomplished with the method, mentioned in the introduction, for production of a connection rod in that the rod part and the cap part are clamped together with a clamping element, especially before they are removed as a whole from the holding jig.

It is of advantage in this process that the microstructure forming at the fracture faces during fracture splitting can be protected better from damage. Thus the precision with which the two parts can be joined together once again is preserved better than when the two separated parts are respectively manipulated separately. In addition, mixup of parts of different connection rods may also be better preventable therewith. The fracture splitting of connecting rods is indeed a mass production process, in which it is entirely possible that the cap parts of connecting rods can be mixed up. The consequence of this is that the microstructures of rod part and cap part no longer fit together and thus rejects are produced. The clamping element may also remain on the connecting rod for its transportation and therefore may be used as a transportation safeguard for fracture-split connecting rods.

According to an embodiment variant of the method, it may be provided that the large connecting-rod eye, in the condition of the connecting rod inserted into the holding jig, projects partly out of the holding jig, and that the clamping element is already disposed on the part of the large connecting-rod eye projecting beyond the holding jig before the removal of the rod part and the cap part from the holding jig is initiated. Thus the clamping element is already disposed on the connecting rod in a very early stage of the removal of the fracture-split connecting rod from the holding jig, whereby the protective effect of the clamping element for the microstructures of the fracture-split faces may be further increased.

According to another embodiment variant of the method, however, it may also be provided that the clamping element is already disposed in the region of the large connecting-rod eye before the introduction of the connecting rod into the holding jig. Stated in other words, the fracture splitting therefore takes place against the clamping force of the clamping element, whereby the fracturing force must indeed be greater, although on the other hand the two separated parts of the connecting rods can be clamped together once again immediately after removal of the fracturing tool, wherewith the danger of the damage of the microstructure of the fracture faces may be further reduced.

According to a further embodiment variant of the method, it may be provided that the clamping element is disposed in a manner extending continuously over a back side of the cap part. Therewith the clamping force may be transmitted more uniformly into the cap part, whereby a tilting of the cap part relative to the rod part may be prevented better. This in turn favors the undamaged preservation of the microstructure of the fracture faces.

Preferably, according to a further embodiment variant of the method, the connecting rod may be produced from a sintered material by powder metallurgy, since therewith the fracture splitting of the large connecting-rod eye may be performed more easily without plastic deformation in the region of the fracture faces. This in turn favors the precise arrangement of the clamping element on the connecting rod.

It may also be provided, however, that the clamping element remains on the connecting rod even during use thereof, i.e. that no further clamping elements, such as threaded bolts, for example, have to be disposed. Thus a further mechanical machining of the connection rod for production of the bolt seats may be omitted, whereby the clamping faces of the cap part and the mating clamping faces of the rod part can be formed in continuous manner. The consequence of this is that the microstructures formed on these faces during fracture splitting cannot be impaired by such a mechanical machining.

### BRIEF DESCRIPTION OF THE DRAWINGS

For better understanding of the invention, it will be explained in more detail on the basis of the following figures.

Therein, respectively in simplified schematic diagrams,

FIGS. 1 to 5 show sectional views from a preferred method sequence at various points in time of the production of a connecting rod.

### DETAILED DESCRIPTION OF PREFERRED EMBODIMENTS

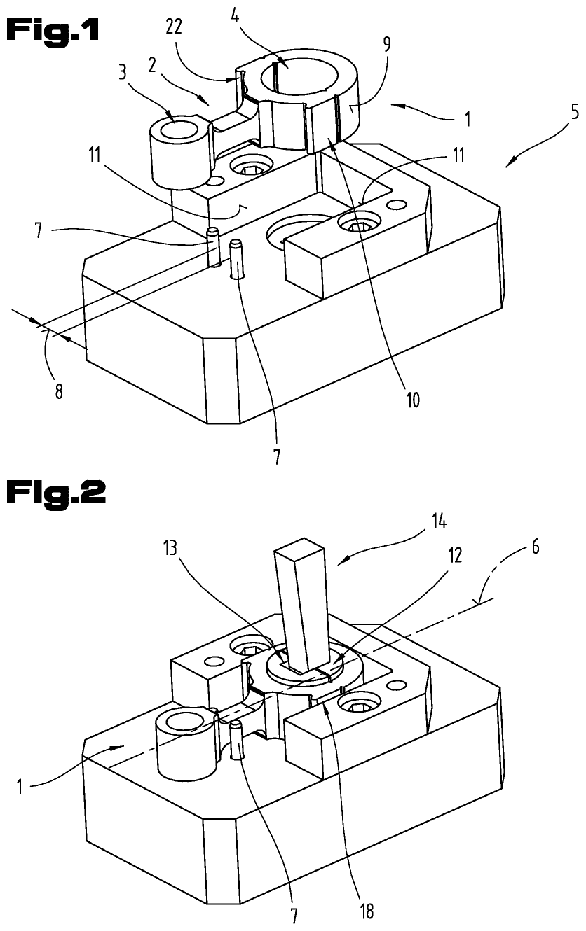

In FIGS. 1 to 5, the production of a fracture-split connecting rod 1 is shown at various points in time of the preferred method.

In general, the connecting rod has a piston rod 2, at one end of which a small connecting-rod eye 3 and at the other end a large connecting-rod eye 4 are formed. The small and the large connecting rod eyes 3, 4 serve as the seat of machine parts to be bearing-mounted. For this purpose, bearing shells or bushes, for example, are inserted in these, or the surface of the small and/or of the large connecting-rod eye 3, 4 itself is formed for the bearing-mounting of machine parts. Since these details are known in themselves from the pertinent prior art, reference is made to that prior art for further details in this respect.

The connecting rod 1 is provided in particular for a compressor of a cooling apparatus.

The connecting rod 1, such as illustrated in FIG. 1, may be produced by a method according to the prior art and therefore, for example, by a casting method. Such a method imparts to the connecting rod 1 a shape with which it is then delivered to the further processing, i.e. the fracture splitting, which will be described in the following. Since such forming methods are likewise known in themselves for connecting rods 1, reference is likewise made to the pertinent prior art for further details in this respect.

The connecting rod 1, which already has its shape as illustrated on the basis of an example in FIG. 1 (in principle, the connecting rod 1 may also have a different shape, although the piston rod 2 and the small and the large connecting-rod eyes 3, 4 are always still present), is transferred, for fracture splitting of the large connecting-rod eye 4, into a holding jig 5, as is illustrated in particular in FIG. 2.

The holding jig 5 is designed in particular in such a way that a relative displacement of the two parts of the connecting rod 1 to be separated during the fracture splitting takes place in the direction of a longitudinal middle axis 6 through the piston rod 2. For this purpose, the holding jig 5 may be provided, for example, with two pins 7 or bolts, which are disposed at a spacing 8 relative to one another, such that the piston rod 2 may indeed be received between the two pins 7, but not the small connecting-rod eye 3, as is shown in FIGS. 2 to 4.

For this purpose of the relative displaceability of the two parts of the piston rod 1 to be separated, however, other constructive embodiment variants of the holding jig 5 are also possible.

Besides this receiving of the connecting rod between the pins 7, the holding jig 5 preferably does not have any further holding elements with which the piston rod and the small connecting-rod eye 3 are held during the fracture splitting (aside from a support face, on which the connecting rod 1 lies in the holding jig 1).

Now that the large connecting-rod eye 4 is being fracture-split, it is of advantage, during the fracture splitting, when this is guided or braced at least in regions in the region of an outer surface 9. For this purpose, flattenings 10, by which a plane face is formed, may be provided on the outer surface 9 of the large connecting-rod eye 4. For example, two flattenings 10 situated opposite one another relative to the longitudinal middle axis 6 through the piston rod may be present. For this purpose, the holding jig 5 may have matching plane faces 11, on which the flattenings 10 bear during fracture splitting of the large connecting-rod eye 4. In this way, inadvertent damage to the connecting rod 1 during the fracture splitting can be prevented.

For this purpose of the bracing of the large connecting-rod eye 4 during fracture splitting, other constructive embodiment variants of the holding jig 5 may also be provided.

After the introduction of the connecting rod 1, which has not yet been fracture-split, into the holding jig 5, the large connecting-rod eye 4 is fracture-split. It must be remarked that, in principle, the small connecting rod eye 3 may also be fracture-split in the manner described here.

For the fracture-splitting, preferably a two-piece bracing cylinder 12 is introduced into the large connecting-rod eye 4. The bracing cylinder 12 may have an outside diameter that corresponds approximately to the inside diameter of the large connecting-rod eye 4. However, it may also have a smaller diameter.

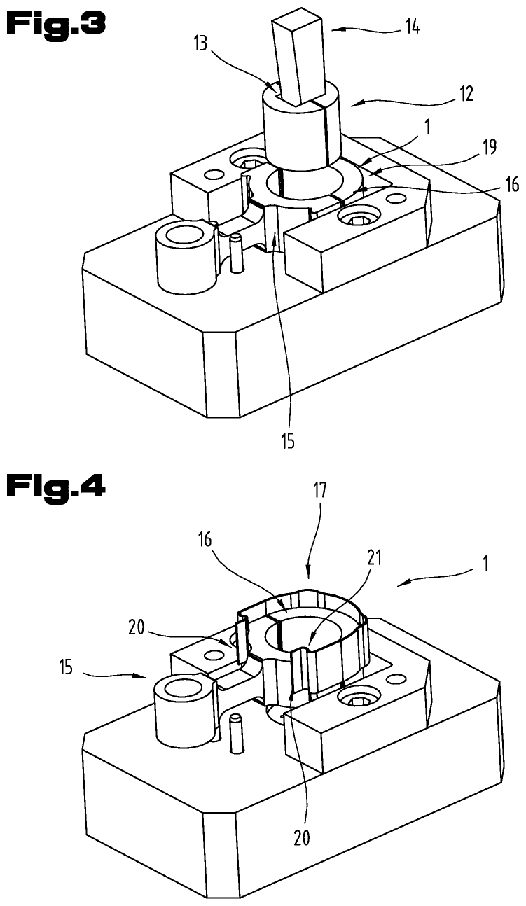

Furthermore, the bracing cylinder 12 is provided centrally with a through-going recess 13 for the receiving of an expansion wedge 14. The expansion wedge 14 is pressed into this recess 13, so that the two parts of the bracing cylinder 12 are pressed radially apart from one another due to its at least one wedge face. This in turn leads to a transmission of force onto the inner shell surface of the large connecting-rod eye 4, whereby this is ultimately fracture-split with formation of a rod part 15 and a cap part 16, as is shown in FIG. 3.

In the illustrated embodiment variant, the recess 13 in the bracing cylinder 12 has a square cross section. However, it may also have a different cross-sectional shape. The cross-sectional shape of the expansion wedge 14 is adapted substantially to the cross-sectional shape of the recess 13 in the bracing cylinder 12.

Instead of the bracing cylinder 12 and the expansion wedge 14, it is also possible, for example, to use a splitting cone without bracing cylinder.

For the fracture splitting—as is known in itself—predetermined fracture sites, for example notches, may be provided on the connecting rod 1.

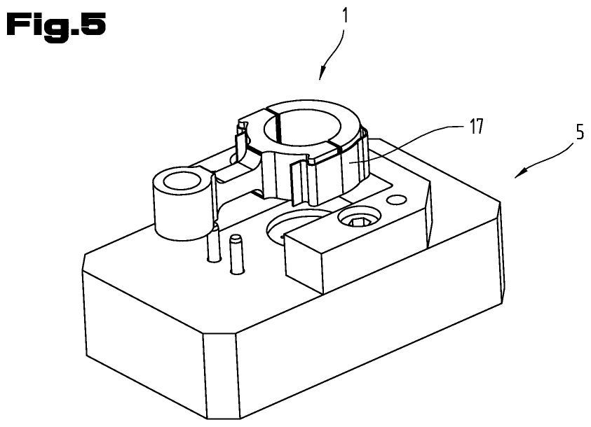

After the fracture splitting of the connecting rod 1, i.e. of the large connecting-rod eye 4, into the rod part 15 and the cap part 16, these two parts are removed from the holding jig 5 (after removal of the expansion wedge 14 and of the bracing cylinder 12, as is illustrated in FIG. 3). In the process, the rod part 15 and the cap part 16 are preferably clamped together with a clamping element 17 before they are removed as a whole, so that these two parts again bear on one another at the formed fracture faces, as shown in FIG. 4. Only then does complete removal of the fracture-split connecting rod 1 together with the clamping element 17 disposed on it from the holding jig 5 take place, as is illustrated in FIG. 5.

As is shown in particular in FIGS. 2 and 3, it may be provided according to an embodiment variant of the method that the large connecting-rod eye 4, in the condition of the connecting rod 1 inserted into the holding jig 5, projects partly out of the holding jig 5. For this purpose, the connecting rod 1 may have, in the direction of the axial direction through the large connecting-rod eye 4, a width that permits this arrangement of the connecting rod 1, or conversely, the holding jig 5 may be made appropriately lower in this direction. In this way, it is ensured that the clamping element 17 may already be disposed on a region of the large connecting-rod eye 4 projecting beyond the holding jig 5 before the removal of the rod part 15 and the cap part 16 from the holding jig 5 is initiated, i.e. before this is moved for removal from the holding jig 5.

According to another embodiment variant of the method, it may be provided that the clamping element 17 is already disposed in the region of the large connecting-rod eye 4 before the introduction of the connecting rod 1 into the holding jig 5, for example as illustrated in the figures for the embodiment variants of the method described in the foregoing. In this embodiment variant, the clamping element 17 must have a certain “elasticity” or compliance in the direction of the longitudinal middle axis 6 through the piston rod 2, so that the relative positioning of rod part 15 to cap part 16 is permitted during the fracture splitting. The clamping element 17 is therefore preferably constructed in general as a spring element or spring clip. This also permits a simple mounting of the clamping element 17.

According to an embodiment variant of the method, as can be seen in FIGS. 4 and 5, the clamping element 17 is preferably disposed in a manner extending continuously over a back side 19 (FIG. 3) of the cap part 16. This back part 19 is the outer shell surface of the cap part 16 of the large connecting-rod eye 4.

In general, the the clamping element 17 is preferably designed in at least approximately U-shaped manner. The two limbs of the clamping element 17 are preferably disposed in a manner bearing on the flattenings 10, described in the foregoing, of the large connecting-rod eye 4. Furthermore, end regions 20 of the clamping element 17 are preferably equipped with a securing element 21, for example with a groove or a bead. These may be received in (clipped into) corresponding slots 22 (FIG. 1) in the rod part 15 in the region of the large connecting-rod eye 4, so that the clamping element 17 can be fastened on the connecting rod 1 in this way. Thus the clamping element 17 also encloses even a part of the rod part 15 in the region of the fracture faces.

Preferably, only one clamping element 17, especially only one spring clip is disposed on the connecting rod 1 for the clamping together of rod part 15 and cap part 16.

In principle, the connecting rod 1 may be made from all materials common for this purpose. Preferably, however, the connecting rod is produced from a sintered material by powder metallurgy.

The fracture faces of the cap part 16 form the clamping faces and the fracture faces of the rod part 15 form mating clamping faces, since the two parts are clamped to one another via these faces. Preferably, the clamping faces of the cap part 16 and the mating clamping faces of the rod part 15 are formed in continuous manner, i.e. no bores are made in these faces. In this way, the fraction of the face for the clamping-together of the rod part 15 with the cap part 16 is not reduced (compared with embodiment variants of a connecting rod in which the two parts are joined to one another by means of threaded bolts).

Finally, it must be pointed out, as a matter of form, that, for better understanding of the structure of the connecting rod 1 or of the holding jig 5, these have not necessarily been illustrated to scale.

Although only a few embodiments of the present invention have been shown and described, it is to be understood that many changes and modifications may be made thereunto without departing from the spirit and scope of the invention.

### LIST OF REFERENCE SYMBOLS

1 Connecting rod
2 Piston rod
3 Connecting-rod eye
4 Connecting-rod eye
5 Holding jig
6 Longitudinal middle axis
7 Pin
8 Spacing
9 Surface
10 Flattening
11 Face
12 Bracing cylinder
13 Recess
14 Expanding wedge
15 Rod part
16 Cap part
17 Clamping element
18 Region
19 Back side
20 End region
21 Securing element
22 Slot

What is claimed is:

1. A method for production of a fracture-split connecting rod (1), according to which a connecting rod (1) having one large and one small connecting-rod eye (3, 4) is introduced into a holding jig (5) and therein the connecting rod (1) is fracture-split in the region of the large connecting-rod eye (4), so that the connecting rod (1) is subdivided into a rod part (15) and a cap part (16), and then the rod part (15) and the cap part (16) are removed from the holding jig (5) once again, wherein the rod part (15) and the cap part (16) are clamped together with a clamping element (17), especially before they are removed as a whole from the holding jig (5).

2. The method according to claim 1, wherein the large connecting-rod eye (4), in the condition of the connecting rod (1) inserted into the holding jig (5), is disposed in a manner projecting partly out of the holding jig (5), and wherein the clamping element (17) is already disposed on the region (18) of the large connecting-rod eye (4) projecting beyond the holding jig (5) before the removal of the rod part (15) and the cap part (16) from the holding jig (5) is initiated.

3. The method according to claim 1, wherein the clamping element (17) is already disposed in the region of the large connecting-rod eye (4) before the introduction of the connecting rod (1) into the holding jig (5).

4. The method according to claim 1, wherein the clamping element (17) is disposed in a manner extending continuously over a back side (19) of the cap part (16).

5. The method according to claim 1, wherein the connecting rod (1) is from a sintered material by powder metallurgy.

6. The method according to claim 1, wherein the clamping faces of the cap part (16) and the mating clamping faces of the rod part (15) are formed in continuous manner.
